(19) United States
(12) Patent Application Publication
(10) Pub. No.: US 2006/0061022 A1
(43) Pub. Date: Mar. 23, 2006

(54) Shock-absorbing device for wheeled vehicle

(76) Inventors: Hung-Shen Chang, Taichung (TW); Ching-Hwan Lin, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/944,023

(22) Filed: Sep. 20, 2004

(51) Int. Cl. B62J 1/02

(52) U.S. Cl. 267/132; 267/133; 267/160; 267/164

(57) ABSTRACT

A shock-absorbing device includes a tapered elastic plate having at least one bent portion and at least one suspending cushion space. Thus, the first fixing piece of the elastic plate has a thickness smaller than that of the second fixing piece of the elastic plate, and the elastic plate has cushion spaces, so that the rider's weight is absorbed completely by the suspending cushion spaces of the elastic plate, thereby providing a shock-absorbing effect to the rider.

### BACKGROUND OF THE INVENTION

1. Field of the Invention

The present invention relates to a shock-absorbing device, and more particularly to a shock-absorbing device for a wheeled vehicle, such as a bicycle or the like.

2. Description of the Related Art

A conventional bicycle comprises a seat tube, a seat post mounted on the seat tube, a seat mounted on the seat post, and a spring mounted between the seat and the seat post. Thus, the spring mounted between the seat and the seat post provides a shock-absorbing effect to absorb the shock or vibration applied on the bicycle by the road, so that the rider feels more comfortable when riding the bicycle. However, when the bicycle is moved on a rugged road, the shock-absorbing effect supplied by the spring is not large enough to completely absorb the shock or vibration applied on the bicycle, thereby easily causing uncomfortable sensation to the rider when riding the bicycle on the rugged road.

### SUMMARY OF THE INVENTION

In accordance with the present invention, there is provided a shock-absorbing device comprising a tapered elastic plate having at least one bent portion and at least one suspending cushion space.

The primary objective of the present invention is to provide a shock-absorbing device for a wheeled vehicle, such as a bicycle or the like so as to provide an excellent shock-absorbing effect.

Another objective of the present invention is to provide a shock-absorbing device, wherein the first fixing piece of the elastic plate has a thickness smaller than that of the second fixing piece of the elastic plate, and the elastic plate has cushion spaces, so that the rider's weight is absorbed completely by the suspending cushion spaces of the elastic plate, thereby providing a shock-absorbing effect to the rider.

A further objective of the present invention is to provide a shock-absorbing device, wherein the inclined angle of the seat is adjusted by rotation of the adjusting knob so as to fit the rider's practical requirement.

A further objective of the present invention is to provide a shock-absorbing device, wherein the backrest is pivotally mounted on the first fixing piece of the elastic plate to provide a support effect to the rider.

A further objective of the present invention is to provide a shock-absorbing device, wherein the elastic plate is formed integrally, thereby decreasing costs of fabrication.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a shock-absorbing device in accordance with the preferred embodiment of the present invention;

FIG. 2 is a plan view of the shock-absorbing device in accordance with the preferred embodiment of the present invention;

FIG. 3 is a plan view of the shock-absorbing device in accordance with the preferred embodiment of the present invention;

FIG. 4 is a schematic cross-sectional operational view of the shock-absorbing device as shown in FIG. 2 in use;

FIG. 5 is a schematic cross-sectional operational view of the shock-absorbing device as shown in FIG. 3 in use;

FIG. 6 is a plan cross-sectional view of a shock-absorbing device in accordance with another embodiment of the present invention; and

FIG. 7 is a plan cross-sectional view of a shock-absorbing device in accordance with another embodiment of the present invention.

### DETAILED DESCRIPTION OF THE INVENTION

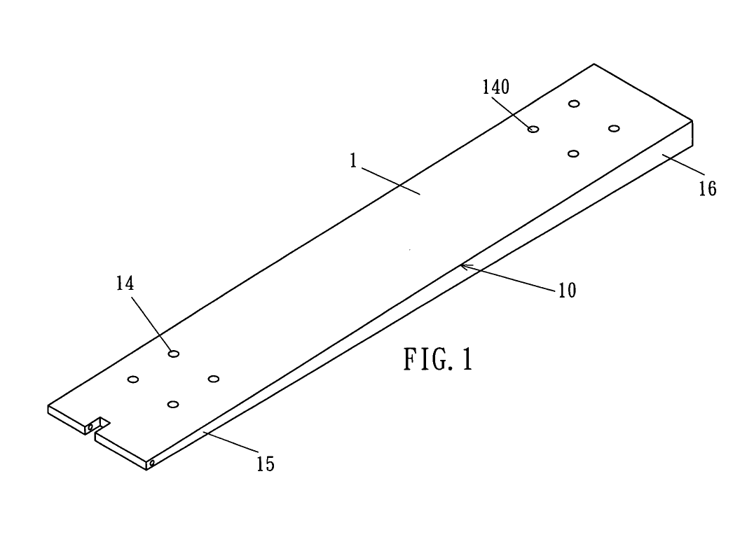

Referring to the drawings and initially to FIGS. 1-3, a shock-absorbing device in accordance with the preferred embodiment of the present invention comprises a tapered elastic plate 10 having at least one bent portion 11 or 12 and at least one suspending cushion space 13.

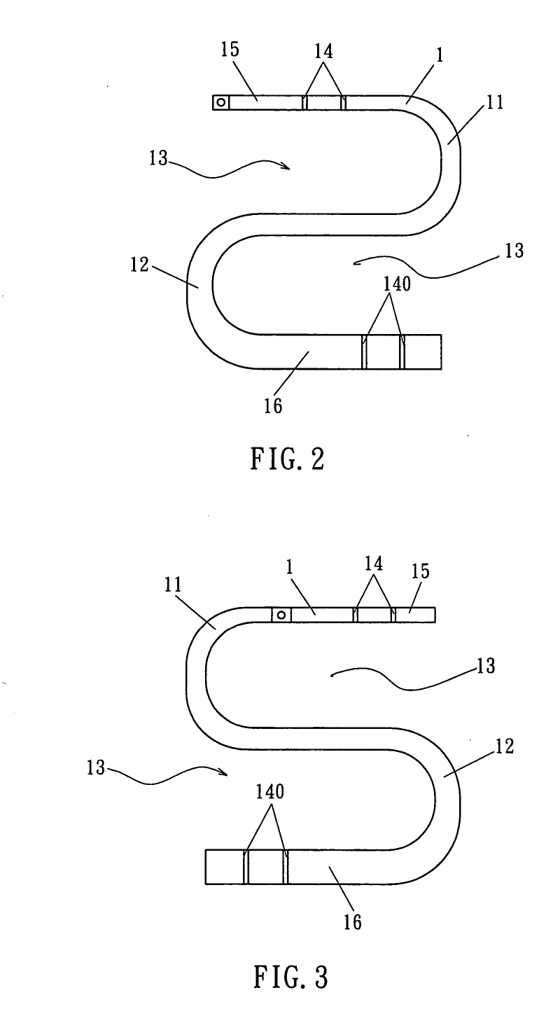

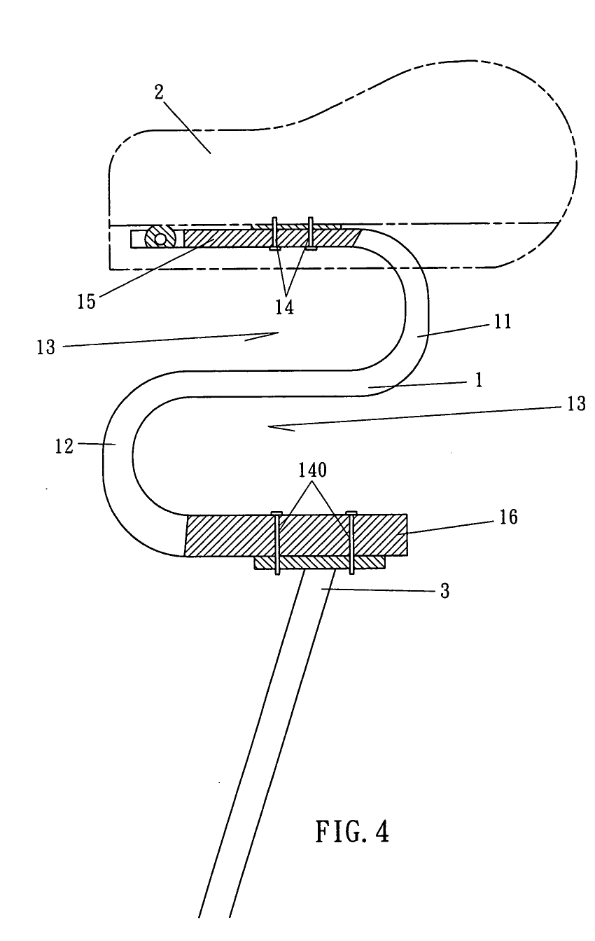

The elastic plate 10 has a first end formed with a first fixing piece 15 formed with a plurality of first fixing holes 14 and a second end formed with a second fixing piece 16 formed with a plurality of second fixing holes 140. The elastic plate 10 has a determined tapered thickness that is gradually increased from the first end to the second end thereof. Thus, the first fixing piece 15 of the elastic plate 10 has a thickness smaller than that of the second fixing piece 16 of the elastic plate 10. The at least one bent portion 11 or 12 and the at least one cushion space 13 are directed toward two different directions. Preferably, the elastic plate 10 has two bent portions 11 and 12 and two suspending cushion spaces 13. In addition, the two bent portions 11 and 12 are directed toward two different directions as shown in FIGS. 2 and 3.

As shown in FIGS. 2 and 3, the elastic plate. 10 is bent is two different manners.

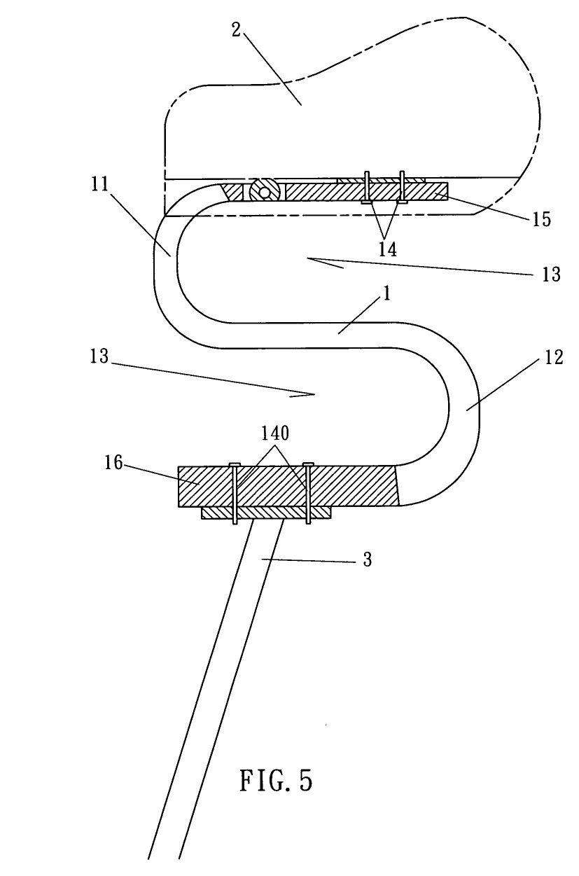

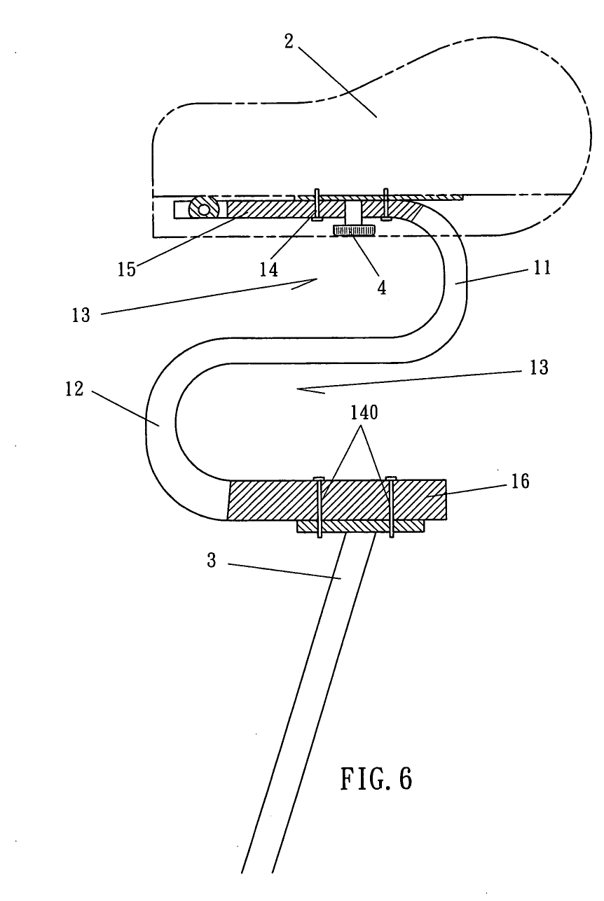

As shown in FIGS. 4 and 5, the first fixing piece 15 of the elastic plate 10 has a plurality of first fixing holes 14 for fixing a seat 2, and the second fixing piece 16 of the elastic plate 10 has a plurality of second fixing holes 140 for fixing a seat post 3. At this time, the first fixing piece 15 of the elastic plate 10 has a thickness smaller than that of the second fixing piece 16 of the elastic plate 10, and the elastic plate 10 has two suspending cushion spaces 13, so that when a rider is seated on the seat 2, the rider's weight is absorbed completely by the two suspending cushion spaces 13 of the elastic plate 10, thereby providing a shock-absorbing effect efficiently to the rider.

As shown in FIG. 6, the shock-absorbing device further comprises an adjusting knob 4 rotatably mounted on the first fixing piece 15 of the elastic plate 10 and having a distal end rested on a bottom of the seat 2 to lift or lower the seat 2 by rotation of the adjusting knob 4 so as to adjust an inclined angle of the seat 2.

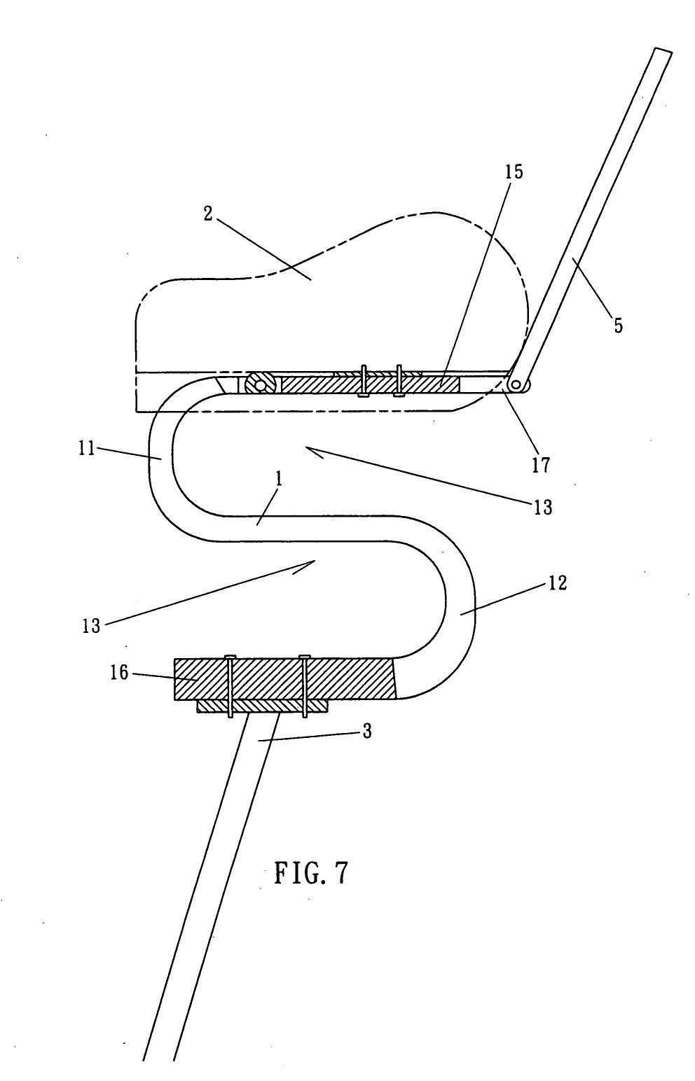

As shown in FIG. 7, the shock-absorbing device further comprises a backrest 5 having a lower end pivotally mounted on a pivot member 17 of the first fixing piece 15 of the elastic plate 10 and located adjacent to the seat 2 to provide a support effect to the rider. The pivot member 17 is formed on a free end of the first fixing piece 15 of the elastic plate 10.

Accordingly, the first fixing piece 15 of the elastic plate 10 has a thickness smaller than that of the second fixing piece 16 of the elastic plate 10, and the elastic plate 10 has cushion spaces 13, so that the rider's weight is absorbed completely by the suspending cushion spaces 13 of the elastic plate 10, thereby providing a shock-absorbing effect to the rider. In addition, the inclined angle of the seat 2 is adjusted by rotation of the adjusting knob 4 so as to fit the rider's practical requirement. Further, the backrest 5 is pivotally mounted on the first fixing piece 15 of the elastic plate 10 to provide a support effect to the rider. Further, the elastic plate 10 is formed integrally, thereby decreasing costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A shock-absorbing device, comprising:
a tapered elastic plate having at least one bent portion and at least one suspending cushion space.

2. The shock-absorbing device in accordance with claim 1, wherein the elastic plate has a first end formed with a first fixing piece and a second end formed with a second fixing piece.

3. The shock-absorbing device in accordance with claim 2, wherein the first fixing piece of the elastic plate is formed with a plurality of fixing holes.

4. The shock-absorbing device in accordance with claim 2, wherein the second fixing piece of the elastic plate is formed with a plurality of fixing holes.

5. The shock-absorbing device in accordance with claim 2, wherein the elastic plate has a determined tapered thickness that is gradually increased from the first end to the second end thereof.

6. The shock-absorbing device in accordance with claim 2, wherein the first fixing piece of the elastic plate has a thickness smaller than that of the second fixing piece of the elastic plate.

7. The shock-absorbing device in accordance with claim 1, wherein the at least one bent portion and the at least one cushion space are directed toward two different directions.

8. The shock-absorbing device in accordance with claim 1, wherein the elastic plate has two bent portions and two suspending cushion spaces.

9. The shock-absorbing device in accordance with claim 8, wherein the two bent portions are directed toward two different directions.

10. The shock-absorbing device in accordance with claim 3, further comprising a seat fixed on the first fixing piece of the elastic plate by the fixing holes of the first fixing piece.

11. The shock-absorbing device in accordance with claim 4, further comprising a seat post fixed on the second fixing piece of the elastic plate by the fixing holes of the second fixing piece.

12. The shock-absorbing device in accordance with claim 10, further comprising an adjusting knob rotatably mounted on the first fixing piece of the elastic plate and having a distal end rested on a bottom of the seat to pivot the seat by rotation of the adjusting knob so as to adjust an inclined angle of the seat.

13. The shock-absorbing device in accordance with claim 10, further comprises a backrest having a lower end pivotally mounted on a pivot member of the first fixing piece of the elastic plate and located adjacent to the seat.

14. The shock-absorbing device in accordance with claim 13, wherein the pivot member is formed on a free end of the first fixing piece of the elastic plate.
